(19) United States
(12) Patent Application Publication
(10) Pub. No.: US 2013/0169919 A1
(43) Pub. Date: Jul. 4, 2013

(54) METHOD FOR MANUFACTURING A LIQUID CRYSTAL DISPLAY

(71) Applicants: Seung Ho Hong, Gunpo-si (KR); Sung-Kyu Hong, Goyang-si (KR); Choong Hwan Kim, Seoul (KR); Se Hyun Lee, Seoul (KR); Hyeok Jin Lee, Seongnam-si (KR); Jae-Soo Jang, Suwon-si (KR)

(72) Inventors: Seung Ho Hong, Gunpo-si (KR); Sung-Kyu Hong, Goyang-si (KR); Choong Hwan Kim, Seoul (KR); Se Hyun Lee, Seoul (KR); Hyeok Jin Lee, Seongnam-si (KR); Jae-Soo Jang, Suwon-si (KR)

(21) Appl. No.: 13/458,398

(22) Filed: Apr. 27, 2012

(30) Foreign Application Priority Data
Jan. 2, 2012 (KR) 10-2012-0000305

(51) Int. Cl. G02F 1/13

(52) U.S. Cl. 349/188

(57) ABSTRACT

A method of manufacturing a liquid crystal display includes: forming a liquid crystal panel including two substrates and a liquid crystal layer interposed between the two substrates and irradiating light to the liquid crystal layer in a state in which a voltage is applied to the liquid crystal panel. The liquid crystal layer includes liquid crystal molecules and a reactive monomer, and the voltage applied to the liquid crystal panel is an AC voltage. The liquid crystal molecules are isotropic in a state that the voltage is not applied thereto and are anisotropic in a state that the voltage is applied thereto.

### CROSS-REFERENCE TO RELATED APPLICATION

This application claims priority to Korean Patent Application No. 10-2012-0000305 filed on Jan. 2, 2012, the entire disclosure of which is hereby incorporated by reference herein in its entirety.

### TECHNICAL FIELD

The present disclosure relates to a method for manufacturing a liquid crystal display.

### DISCUSSION OF THE RELATED ART

A liquid crystal display may display an image by using an optical characteristic (refractive anisotropy or birefringence) and an electrical characteristic (dielectric anisotropy) of a liquid crystal material. The liquid crystal display may have such as, for example, a thin thickness, a low driving voltage, and low power consumption compared with other display devices such as a CRT (cathode ray tube) and a PDP (plasma display panel).

The nematic phase liquid crystal has been used in the liquid crystal displays. However, the response time of a liquid crystal display which includes nematic phase liquid crystals, to an electric field may be limited when applied to a 3D display device or a high resolution display device.

Accordingly, there has been an attempt to use a different liquid crystal phase from the nematic phase such as, for example, liquid crystals in a blue phase in which the liquid crystals voluntarily form a lattice structure such as a blue phase liquid crystal structure. A blue phase liquid crystal structure may have optical isotropy without application of the voltage.

The liquid crystals of the blue phase has a characteristic that it may be changed from isotropic to anisotropic according to a magnitude of the applied voltage such that the response speed of the liquid crystal display may be increased. However, there may be a drawback in that the liquid crystals of the blue phase may require a high driving voltage.

### SUMMARY

Exemplary embodiments of the present invention may provide a method of manufacturing a liquid crystal display that may reduce a driving voltage and reduce hysteresis while realizing a liquid crystal of a blue stable phase through a wide temperature range.

A method of manufacturing a liquid crystal display according to an exemplary embodiment of the present invention includes: forming a liquid crystal panel including two substrates and a liquid crystal layer interposed between the two substrates and irradiating light to the liquid crystal layer in a state that a voltage is applied to the liquid crystal panel. The liquid crystal layer includes liquid crystal molecules and a reactive monomer, and the voltage applied to the liquid crystal panel is an AC voltage. The liquid crystal molecules are isotropic in a state that the voltage is not applied thereto and are anisotropic in a state that the voltage is applied thereto.

The method may further include selecting a frequency of the AC voltage. In the selecting of the frequency of the AC voltage, the frequency at which a transmittance change is minimized at a time that a polarity of the AC voltage is changed may be selected, and the liquid crystal layer may be irradiated with the light in a state that the voltage having the selected frequency is applied to the liquid crystal panel.

The method may further include selecting a magnitude of the AC voltage. In the selecting of the magnitude of the AC voltage, a voltage-transmittance curved line of the liquid crystal panel may be measured before irradiating the light to the liquid crystal layer to measure a voltage of a position where a first turning point is generated, and an AC voltage having a lesser magnitude than the measured voltage may be selected, and in a state in which the voltage having the selected magnitude is applied to the liquid crystal panel, the liquid crystal layer may be irradiated with the light.

The AC voltage may be a triangular wave or a square wave.

The liquid crystal layer may include blue phase liquid crystal molecules and a reactive monomer.

The reactive monomer may be polymerized when irradiating the light to the liquid crystal layer.

A method for stabilizing a blue phase liquid crystal structure according to an exemplary embodiment of the present invention includes providing a material which includes a blue phase liquid crystal structure and a reactive monomer and polymerizing the reactive monomer with the blue phase liquid crystal structure to form a polymer stabilized blue phase liquid crystal structure. A voltage is applied to the material during the polymerization process, and liquid crystal molecules of the polymer stabilized blue phase liquid crystal structure are isotropic in a state that the voltage is not applied thereto and are anisotropic in a state that the voltage is applied thereto.

A method for stabilizing a blue phase liquid crystal structure according to an exemplary embodiment of the present invention includes selecting a frequency of an alternating current (AC) voltage to apply to a mixture of a blue phase liquid crystal structure and a reactive monomer, and in the selecting of the frequency of the AC voltage, the frequency at which a transmittance change is minimized at a time that a polarity of the AC voltage is changed is selected. The method further includes irradiating ultraviolet (UV) light on the mixture of the blue phase liquid crystal structure and the reactive monomer to form a polymer chain on an area disposed between a pair of double twist cylinders of a cubic structure of the blue phase liquid crystal structure. The AC voltage having the selected frequency is applied to the mixture during the polymerization process, and liquid crystal molecules of the blue phase liquid crystal structure are isotropic in a state that the voltage is not applied thereto and are anisotropic in a state that the voltage is applied thereto.

As described above, according to an exemplary embodiment of the present invention, the light is irradiated to the reactive monomer mixed with the liquid crystal molecules in the state that the AC voltage is applied to the mixture of the reactive monomer and the liquid crystal molecules such that the driving voltage of the liquid crystal display may be reduced and the hysteresis may be reduced.

### BRIEF DESCRIPTION OF THE DRAWINGS

Exemplary embodiments of the present invention can be understood in more detail from the following detailed description taken in conjunction with the accompanying drawings, in which:

FIG. 1 is a view of a blue phase liquid crystal structure.

FIG. 2 is a view showing a blue phase I structure and a blue phase II structure.

FIG. 3 is a view of a dependency of a molecule structure of a chiral nematic liquid crystal for a temperature and chirality.

FIG. 4 to FIG. 7 are views of a method of maintaining a blue phase liquid crystal structure at room temperature according to an exemplary embodiment of the present invention.

FIG. 8 is a graph of a relationship between an application voltage and transmittance according to an exemplary embodiment of the present invention.

FIG. 9 is a graph showing a change of transmittance according to an applied voltage according to an exemplary embodiment of the present invention.

FIG. 10 is a graph of transmittance while increasing and decreasing a voltage.

### DETAILED DESCRIPTION OF EXEMPLARY EMBODIMENTS

Exemplary embodiments of the present invention will be described more fully hereinafter with reference to the accompanying drawings, in which exemplary embodiments of the invention are shown. Exemplary embodiments of the present invention may be embodied in various different ways and should not be construed as limited to exemplary embodiments described herein.

In the drawings, the thickness of layers, films, panels, regions, etc., are exaggerated for clarity. It will be understood that when an element such as, for example, a layer, film, region, or substrate is referred to as being “on”, “connected to” or “coupled to” another element, it can be directly on, connected to or coupled to the other element or intervening elements may also be present. Like reference numerals designate like elements throughout the specification.

As used herein, the singular forms, “a”, “an”, and “the” are intended to include plural forms as well, unless the context clearly indicates otherwise.

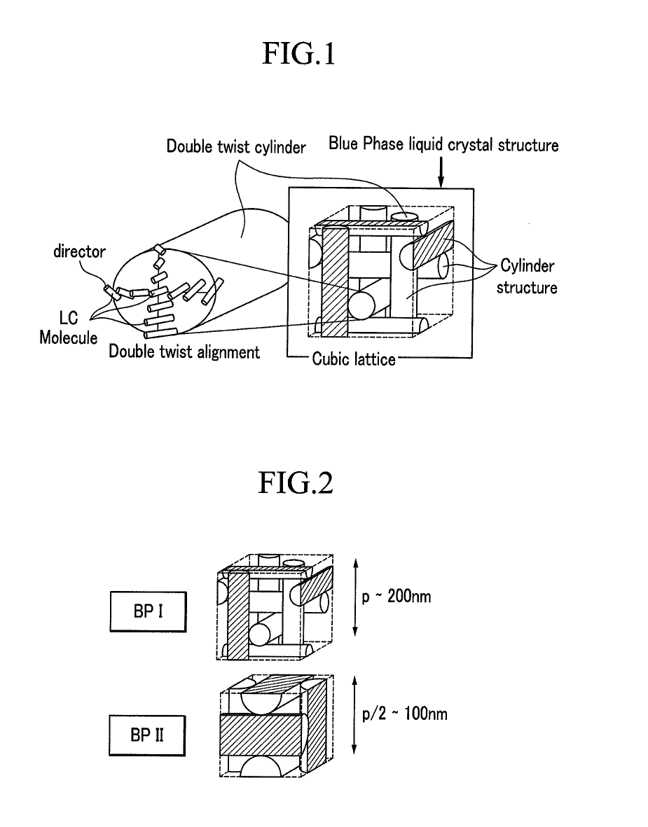

FIG. 1 is a view of a blue phase liquid crystal structure. A blue phase liquid crystal structure is made of a cubic lattice structure represented as a quadrangle in FIG. 1. One cubic lattice structure unit includes a plurality of cylinder structures. Also, each cylinder structure is made of, for example, twisted liquid crystal molecules. Each of the cylinder structures are referred to as a double twist cylinder.

The blue phase liquid crystal structure has optical isotropy in the absence of a voltage. If an appropriate electric field is applied to the blue phase liquid crystal structure, the liquid crystal molecules are arranged perpendicular or parallel to the applied electric field according to the dielectric anisotropy of the liquid crystal molecules.

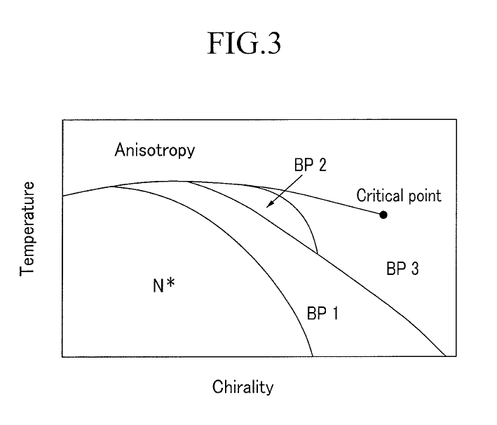

The blue phase liquid crystal structure may be provided in various forms. For example, FIG. 2 is a view of a blue phase I (BP I) structure and a blue phase II (BP II) structure. The blue phase I (BP I) has a body centered cubic (BCC) lattice structure, and the blue phase II (BP II) has a simple cubic lattice structure.

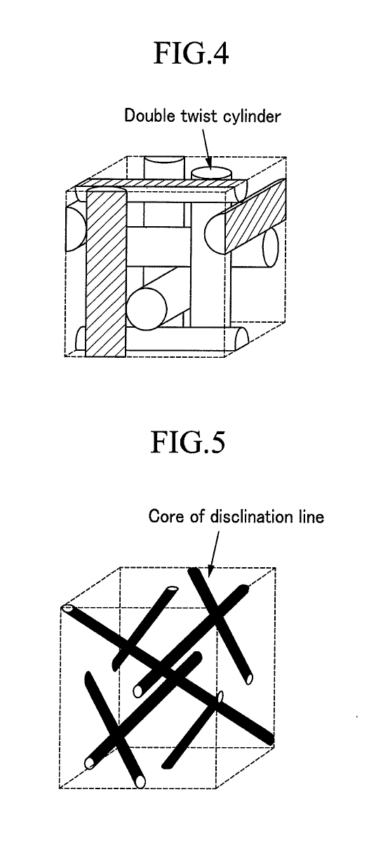

FIG. 3 is a view of a dependency of a molecule structure of a chiral nematic liquid crystal for temperature and chirality. The horizontal axis represents chirality, and the vertical axis represents temperature. The liquid crystal molecules are close to the blue phase liquid crystal molecule when the chirality is high, and the liquid crystal molecules are close to the nematic phase liquid crystal molecule when the chirality is low. The liquid crystal molecules have isotropy at a high temperature, and they have the nematic liquid crystal characteristic at a low temperature. In the graph illustrated in FIG. 3, three blue phase liquid crystals, i.e., BP 1, BP 2, and BP 3, are shown. The BP 3 represents a structure having the same symmetry as the isotropicity.

When the chirality of the liquid crystal is high, the blue phase temperature range is wide. Accordingly, if the chirality of the liquid crystal is appropriately controlled, the liquid crystal may have the blue phase at room temperature. However, in a case of the liquid crystal material that has been particularly applied, it may be difficult for the liquid crystal material to have the blue phase at room temperature, and instead the liquid crystal material may have a chiral nematic or a cholesteric structure.

Accordingly, to broaden the temperature range in which the liquid crystal material may be in the blue phase, a reactive monomer, a reactive prepolymer or reactive oligomer may be added to the liquid crystal material such that a polymer may be formed through a photo-polymerization process in which light is irradiated to the chiral nematic liquid crystal having the blue phase. The light may include ultraviolet (UV) light, visible light, infrared light, and a combination thereof. In the present exemplary embodiment, UV light is used to irradiate the liquid crystal material.

Alternatively, instead of using photo-polymerization, the reactive monomer, the reactive prepolymer or the reactive oligomer may be added to the liquid crystal material such that a polymer may be formed through a thermal polymerization process in which a mixture of the liquid crystal material and the reactive monomer, the reactive prepolymer or the reactive oligomer is heated.

The reactive monomer may include, for example, an acrylate-based monomer, which may be polymerized by heat or ultraviolet rays. However, exemplary embodiments of the present invention are not limited thereto. For example, materials including a polarization group such as a vinyl group, an acryloyl group, a fumarate group, and the like may be used as the reactive monomer. Furthermore, an initiator, which may initiate the polymerization of the reactive monomer may also be added to the liquid crystal material. For example, acetophenone, benzophenone, or the like may be used as the initiator.

In addition, the liquid crystal material mixed with the reactive monomer may include, for example, low molecular weight liquid crystals that can change to the blue-phase state in a temperature range between a chiral phase and an isotropic phase. For example, the low molecular weight liquid crystals may include a molecular structure of a biphenyl, a cyclohexyl, or the like.

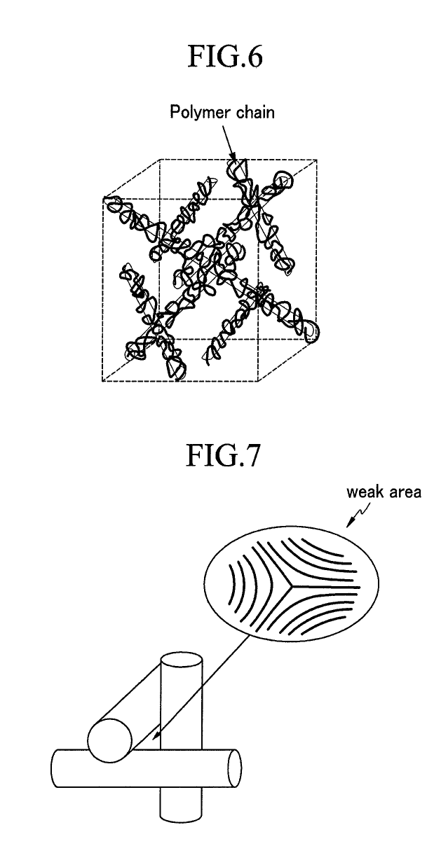

FIG. 4 to FIG. 7 are views of a method of maintaining a blue phase liquid crystal structure at room temperature according to an exemplary embodiment of the present invention. As one example of this method, the reactive monomer that is polymerized by the light, e.g. ultraviolet rays, is dispersed in the liquid crystal material. After the liquid crystal material dispersed with the reactive monomer corresponding to a photo-polymerization material is injected into the liquid crystal panel, the liquid crystal material is heated to a temperature where it has the blue phase liquid crystal structure and the liquid crystal material is exposed to photo-polymerize the reactive monomer dispersed in the liquid crystal material. Alternatively, instead of photo-polymerizing the reactive monomer, the reactive monomer may instead be polymerized through a thermal polymerization process in which a mixture of the liquid crystal material and the reactive monomer is heated.

A weak area within the blue phase liquid crystal structure is shown in FIG. 7. If the double twist cylinder is disposed in the simple cubic lattice or the body centered cubic structure, a weak area may exist between the double twist cylinders and the liquid crystal molecules may be arranged in an unstable state in the weak area. The weak area may make a disclination lines within the blue phase liquid crystal structure like the center area of FIG. 4 which shows the cores of the disclination lines. FIG. 5 represents an axis of the disclination lines. If other materials are dispersed in the blue phase liquid crystal structure, the other materials may readily flow into the weak area such that the other materials are moved toward the disclination lines.

If the liquid crystal material within the liquid crystal panel is exposed to light, the dispersed materials are photo-polymerized. The other materials within the blue phase liquid crystal structure may readily flow into the weak area such that the photo-polymerization material also flows into the weak area and is photo-polymerized at the position thereof, as shown in FIG. 6, and thereby a polymerization combination is formed in the weak area. A polymer chain formed by the photo-polymerization forms a frame such that the polymer chain maintains the blue phase liquid crystal structure in the case that the liquid crystal material is cooled to room temperature.

As described above, a blue phase mode display device including the liquid crystal layer which includes the blue phase liquid crystal structure may have a fast response speed in response to the change of the electric field, and may display an image of high quality in a viewing angle of a wide range.

However, the liquid crystal display having the liquid crystal layer formed by the polymer stabilization method to maintain the blue phase liquid crystal structure in awide temperature range including room temperature may increase the power consumption of the liquid crystal display because the blue phase liquid crystal structure may cause the driving voltage to be higher than the driving voltage of a liquid crystal display of a general wide viewing angle liquid crystal mode. In addition, the blue phase liquid crystal structure may also cause an unstable electrical optical characteristic such as hysteresis to be generated. Here, if the hysteresis is generated, a screen dragging phenomenon may also be generated by differentiating a voltage-transmittance curved line represented when increasing the driving voltage and the voltage-transmittance curved line represented when decreasing the driving voltage in a voltage-transmittance graph, and thereby the response time may appear to be slow.

According to an exemplary embodiment of the present invention, two substrates are provided and a mixture including the liquid crystal material of the blue phase liquid crystal structure and the reactive monomer is injected between two substrates to form the liquid crystal panel. The two substrates may each be formed of, for example, glass or a flexible bendable material. For example, the flexible bendable material may be a plastic such as, e.g., polyethylene terephthalate (PET). Here, the liquid crystal material of the blue phase liquid crystal structure is optically isotropic in the state that the voltage is not applied, and is changed to the optically anisotropic in the state that the voltage is applied.

Also, to maintain the blue phase liquid crystal structure by using the above-described polymer stabilization method, a predetermined voltage is applied when exposing the liquid crystal material. For example, the applied voltage is an AC voltage. For example, the AC voltage may be one of a triangular wave or a square wave. A frequency of the AC voltage is selected for a transmittance change that accompanies the change of the polarity of the voltage applied to the liquid crystal according to a kind and a characteristic of the liquid crystal to be minimized. In other words, a degree of the transmittance change generated when the polarity of the voltage is changed according to the frequency of the AC voltage may be changed, and the liquid crystal material is exposed in the state that the voltage having the AC frequency minimizing the degree of the transmittance change is applied.

Also, the magnitude of the voltage may also be changed according to the characteristic of the used liquid crystal, and at this time, the voltage-transmittance curved line is generally measured before the polymer stabilization such that the voltage at which the luminance of a dark state is minimized after the polymer stabilization is selected by using the lesser magnitude than the voltage corresponding to a turning point of the voltage-transmittance curved line.

In the liquid crystal display of a super vertical alignment (SVA) mode, there is a case that the reactive monomer is mixed in the liquid crystal material for light irradiation. However, the reactive monomer of the liquid crystal display of the SVA mode may be mixed with the liquid crystal material in a small amount such that a pretilt of the liquid crystal molecule may be formed in the surface of the liquid crystal layer. However, the reactive monomer according to the present exemplary embodiment forms the liquid crystal layer along with the liquid crystal molecules of the blue phase liquid crystal structure such that a large amount of the reactive monomer may be mixed with the liquid crystal material and may be distributed over the entire liquid crystal layer.

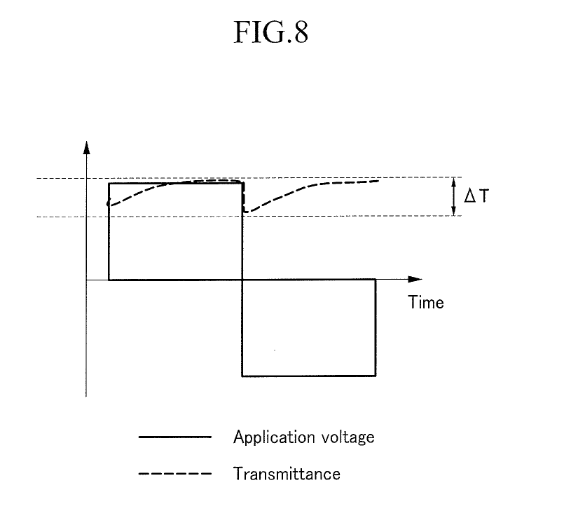

FIG. 8 is a graph of a relationship between an application voltage and transmittance according to an exemplary embodiment of the present invention.

Referring to FIG. 8, a change (ΔT) of the transmittance is generated at a time that an application voltage is changed from a positive polarity to a negative polarity. This transmittance change (ΔT) may be different according to the AC voltage frequency, and according to the present exemplary embodiment, the frequency that minimizes the transmittance change (ΔT) is selected among the AC voltage frequencies.

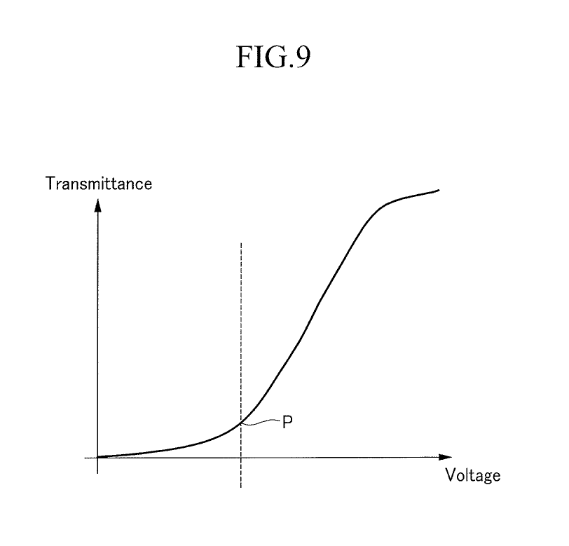

FIG. 9 is a graph showing a change of transmittance according to an application according to the present exemplary embodiment. In detail, FIG. 9 shows a voltage-transmittance curved line before polymer stabilization.

Referring to FIG. 9, a turning point P is generated by the applied voltage to the transmittance curved line. According to the present exemplary embodiment, the AC voltage is applied in the range having the lesser magnitude than the voltage at the turning point P of FIG. 9. If a voltage of more than the turning point P is applied, the blue phase liquid crystal structure may be broken.

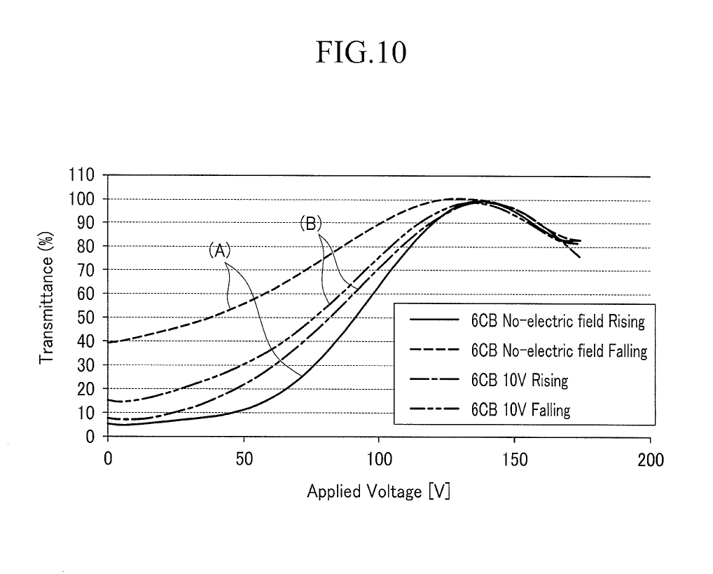

FIG. 10 is a graph of transmittance while increasing and decreasing a voltage.

In detail, FIG. 10 shows the transmittance of a liquid crystal display including a liquid crystal layer formed by irradiating ultraviolet rays to a mixture of a hexyl-cyanobiphenyl (6CB) liquid crystal material and a reactive monomer in a no-electric field state according to Comparative Example (A). In addition, FIG. 10 also shows the transmittance of a liquid crystal display including a liquid crystal layer formed by irradiating ultraviolet rays to a mixture of a 6CB liquid crystal material and a reactive monomer in a state when about a 10V electric field is applied according to an exemplary embodiment of the present invention (B).

Referring to FIG. 10, in the liquid crystal display according to an exemplary embodiment of the present invention (B), the width between the transmittance curved line when increasing the electric field and the transmittance curved line when decreasing the electric field is far reduced compared with Comparative Example (A). Accordingly, in the liquid crystal display according to the present exemplary embodiment, the hysteresis may be reduced.

Also, in an aspect that the curved line representing the transmittance change when increasing the voltage in an exemplary embodiment of the present invention (B) is shifted to a side of the curved line representing the transmittance change when increasing the voltage in Comparative Example (A), it may be confirmed that the driving voltage is decreased.

As described above, a method of manufacturing a liquid crystal display according to an exemplary embodiment of the present invention includes irradiating light on a liquid crystal layer in a state that the AC voltage is applied to the liquid crystal panel such that the blue phase liquid crystal structure of the liquid crystal layer is polymer-stabilized, has isotropy in the state of having no electric field and has predetermined directivity (e.g., the direction that the liquid crystal is inclined under the application of the driving voltage). Consequently, the driving voltage of a liquid crystal display manufactured according to exemplary embodiments of the present invention may be decreased and the hysteresis may be reduced.

Having described exemplary embodiments of the present invention, it is further noted that it is readily apparent to those of reasonable skill in the art that various modifications may be made without departing from the spirit and scope of the invention which is defined by the metes and bounds of the appended claims.

What is claimed is:

1. A method of manufacturing a liquid crystal display, comprising:
forming a liquid crystal panel including two substrates and a liquid crystal layer interposed between the two substrates; and
irradiating light to the liquid crystal layer in a state that a voltage is applied to the liquid crystal panel,
wherein the liquid crystal layer includes liquid crystal molecules and a reactive monomer,
wherein the voltage applied to the liquid crystal panel is an alternating current (AC) voltage, and
wherein the liquid crystal molecules are isotropic in a state that the voltage is not applied thereto and are anisotropic in a state that the voltage is applied thereto.

2. The method of claim 1, further comprising
selecting a frequency of the AC voltage,
wherein in the selecting of the frequency of the AC voltage, the frequency at which a transmittance change is minimized at a time that a polarity of the AC voltage is changed is selected, and
wherein the liquid crystal layer is irradiated with the light in a state that the voltage having the selected frequency is applied to the liquid crystal panel.

3. The method of claim 2, further comprising
selecting a magnitude of the AC voltage, wherein in the selecting of the magnitude of the AC voltage, a voltage-transmittance curved line of the liquid crystal panel is measured before irradiating the light to the liquid crystal layer to measure a voltage of a position where a first turning point is generated, and the AC voltage having a lesser magnitude than the measured voltage is selected, and
wherein in a state in which the AC voltage having the selected magnitude is applied to the liquid crystal panel, the liquid crystal layer is irradiated with the light.

4. The method of claim 3, wherein
the AC voltage is one of a triangular wave and a square wave.

5. The method of claim 4, wherein
the liquid crystal layer includes blue phase liquid crystal molecules and a reactive monomer.

6. The method of claim 5, wherein
the reactive monomer is polymerized when irradiating the light to the liquid crystal layer.

7. The method of claim 1, wherein
the liquid crystal layer includes blue phase liquid crystal molecules and a reactive monomer.

8. The method of claim 7, wherein
the reactive monomer is polymerized when irradiating the light to the liquid crystal layer.

9. The method of claim 1, further comprising
selecting a magnitude of the AC voltage, wherein in the selecting of the magnitude of the AC voltage, a voltage-transmittance curved line of the liquid crystal panel is measured before irradiating the light to the liquid crystal layer to measure a voltage of a position where a first turning point is generated, and the AC voltage having a lesser magnitude than the measured voltage is selected, and
wherein in a state in which the AC voltage having the selected magnitude is applied to the liquid crystal panel, the liquid crystal layer is irradiated with the light.

10. The method of claim 9, wherein
the liquid crystal layer includes blue phase liquid crystal molecules and a reactive monomer.

11. The method of claim 10, wherein
the reactive monomer is polymerized when irradiating the light to the liquid crystal layer.

12. A method for stabilizing a blue phase liquid crystal structure, comprising:
providing a material which includes a blue phase liquid crystal structure and a reactive monomer; and
polymerizing the reactive monomer with the blue phase liquid crystal structure to form a polymer stabilized blue phase liquid crystal structure, wherein a voltage is applied to the material during the polymerization process, and
wherein liquid crystal molecules of the polymer stabilized blue phase liquid crystal structure are isotropic in a state that the voltage is not applied thereto and are anisotropic in a state that the voltage is applied thereto.

13. The method of claim 12, wherein the blue phase liquid crystal structure is formed by heating a liquid crystal material prior to the polymerization process.

14. The method of claim 12, wherein the polymerizing of the reactive monomer with the blue phase liquid crystal structure includes exposing the blue phase liquid crystal structure and irradiating the exposed blue phase liquid crystal structure with a light.

15. The method of claim 14, wherein the light is an ultraviolet (UV) light.

16. The method of claim 12, wherein the voltage is an alternating current (AC) voltage, the method further comprising:
selecting a frequency of the AC voltage,
wherein in the selecting of the frequency of the AC voltage, the frequency at which a transmittance change is minimized at a time that a polarity of the AC voltage is changed is selected, and
wherein the blue phase liquid crystal structure is irradiated with the light in a state that the voltage having the selected frequency is applied to the blue phase liquid crystal structure.

17. The method of claim 12, wherein the reactive monomer includes an acrylate-based monomer.

18. The method of claim 12, wherein the reactive monomer is composed of a material including a polarization group selected from the group consisting of a vinyl group, an acryloyl group, or a fumarate group.

19. A method for stabilizing a blue phase liquid crystal structure, comprising:
selecting a frequency of an alternating current (AC) voltage to apply to a mixture of a blue phase liquid crystal structure and a reactive monomer, wherein in the selecting of the frequency of the AC voltage, the frequency at which a transmittance change is minimized at a time that a polarity of the AC voltage is changed is selected; and
irradiating ultraviolet (UV) light on the mixture of the blue phase liquid crystal structure and the reactive monomer to form a polymer chain on an area disposed between a pair of double twist cylinders of a cubic structure of the blue phase liquid crystal structure, wherein the AC voltage having the selected frequency is applied to the mixture during the polymerization process, and
wherein liquid crystal molecules of the blue phase liquid crystal structure are isotropic in a state that the voltage is not applied thereto and are anisotropic in a state that the voltage is applied thereto.
